(19) United States
(12) Patent Application Publication
(10) Pub. No.: US 2009/0110156 A1
(43) Pub. Date: Apr. 30, 2009

(54) Method and apparatus for the storage of recorded audio and retrieval from an associated URL

(76) Inventors: Joseph Hosteny, Pittsburgh, PA (US); David Graham, Cranberry Township, PA (US)

Correspondence Address: Niro, Scavone, Haller & Niro, Suite 4600, 181 W. Madison, Chicago, IL, 60602, US

(21) Appl. No.: 11/978,236

(22) Filed: Oct. 27, 2007

(51) Int. Cl. H04M 1/64

(52) U.S. Cl. 379/85

(57) ABSTRACT

A telephone call is placed to a PBX server. A PBX integrator connected to the PBX server looks up the caller in a database, and creates a new user record if necessary. The PBX server records part or all of the call, and transfers the recording to the integrator. The integrator creates a record in the database for the recording including information such as a URL about the location of the file and uploads the recording to a storage site via a file uploader. Recordings can be accessed from a site, such as a web server, according to various criteria that can be created by a user. Various security and identification features are included.

### BACKGROUND OF THE INVENTION

The invention pertains to the recording of audio streams in telephone calls, and the processing of those recordings in a manner where the recordings may be replayed on an accessible site, such as a web server on the internet, where a user can search for recordings according to various criteria, and play the desired recording. The process converts a telephone call, if necessary, from a conventional call to a voice over IP format (VoIP). Various instructions can be issued to the caller. Records are created in a database and contain information about the identity of the user, the recordings, the locations were the recordings are posted for listening, and other information such as billing information. The process records at least part of the call, and transfers it to a storage location. The servers used in the processes can be either physical or virtual machines. Optionally, additional processes can be included for marking recordings to various groups created on the site, for marking recordings as private, for adding users to or deleting them from groups for authentication and for prevention of unwanted intrusions, such as spoofing.

### SUMMARY OF THE INVENTION

The invention relates to apparatuses and methods, with various embodiments and optional features, for recording the content of a telephone call placed by a caller to a PBX (private branch exchange) server. This machine, in communication with another server, a PBX integrator, receives a call from a user, provides various instructions to the user, and records at least part of the telephone call. If the call is placed from a conventional telephone system, the call is translated to an appropriate format. The PBX server and integrator create records for users, and store those records on a database server. Recordings are uploaded to a storage location, with an assigned URL that is also stored in a record. The apparatus and method includes a publicly addressable server that can be accessed by users. A user accessing the server can identify and play a recording using the telephone number of the calling user.

The PBX server and integrator can also accomplish additional functions, such as authentication of a user, and prevention of spoofing, for example, a user pretending to be another user. The publicly addressable server may be a web server. It can accomplish additional functions, such as allowing a user to mark recordings as private, and to create groups of persons to be allowed access to recordings. The various servers can be physical machines, or can be instances of virtual machines, or a combination of physical and virtual machines.

### DESCRIPTION OF THE DRAWINGS

FIG. 1 is a sequence diagram depicting the operation of an embodiment of the service.

FIGS. 2 and 2b are depictions of two typical screens as seen by a user.

FIG. 3 is a block diagram of the apparatus.

### DETAILED DESCRIPTION OF THE INVENTION

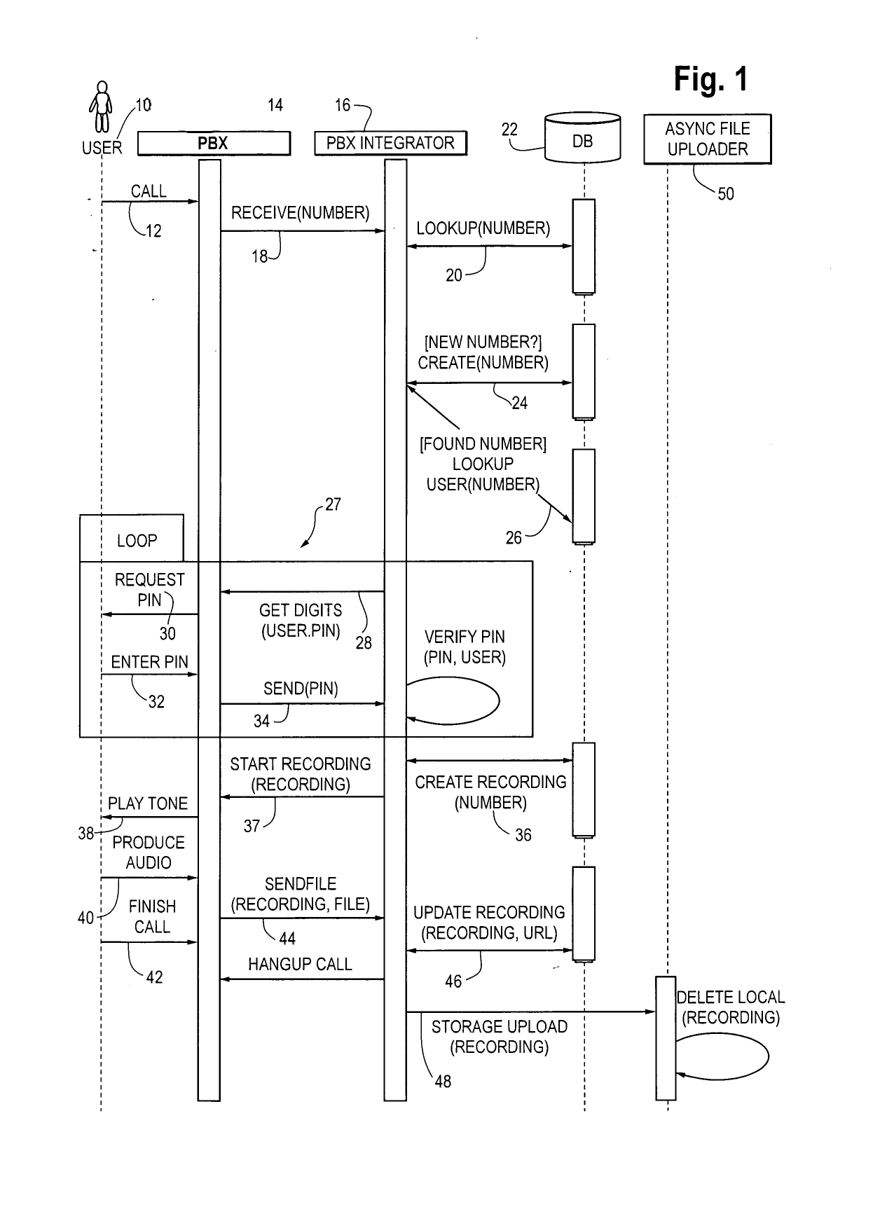

The service allows recording of audio from a telephone, and posting of the recording immediately to a website without any special intervention on the part of a user of the telephone. Refer to FIG. 1, the sequence diagram, which depicts a typical flow of this embodiment of the service. In FIG. 1, the vertical direction or Y-axis represents time, with commencement at the top. The horizontal direction, or X-axis, represents events occurring at a particular time. Arrows represent messages sent by a user or by processes, for example, code executing on a machine. An arrow with a single head represents asynchronous messages. An arrow with two heads represents a synchronous message. In one embodiment, the servers depicted in FIG. 1 are virtual machines. In another embodiment, they are physical machines. In a third embodiment, they are a combination of the two.

To initiate a recording, a user 10 dials a specific number, for example, 1-877-mic-hand in this example. A telephone call 12 is translated, if necessary, from a regular POTS (plain old telephone service) call to a VoIP (Voice over IP) call by an intermediary. Telephone calls using services such as Skype do not require translation. Thus, the intermediary is not shown in FIG. 1 because it is not always necessary. Currently available intermediary services are, for example, Global Crossing, 110 East 59^{th} Street, New York, N.Y., 10022 (www.globalcrossing.com) or Teliax, 1001 16^{th} Street, B-180, #1-2, Denver, Colo., 80265 (www.teliax.com). Once translated, the VoIP call is then routed to a PBX server 14, which accepts the call and the subsequent audio stream. The call is originated by user 10 and terminated at PBX server 14. It is not a recording of a call between two parties on the POTS.

If the user 10 has not called before, he is given a short audio description of the service before the recording starts (including where to find his recording on the web). Internally, a determination whether the user is a new caller is done by a database lookup accomplished by a PBX integrator 16 that receives a message 18, “receive (Number),” from PBX server 14. First, the caller ID is checked by communication 20 between PBX integrator 16 and a database 22 to see if that specific telephone has originated a call before. If no record exists in database 22, a new record is generated in the database 22 for that telephone number represented by communication 24, “create (Number),” between the processes on PBX integrator 16 and database 22. The variable “Number” is the telephone number used by user 10. If user 10 is known, database 22 communicates accordingly with PBX Integrator 16 via message 26 to look up user 10. Asterisk®, an open source software implementation of a PBX by Digium, and Adhearsion, are one way to implement PBX server 14 and PBX integrator 16.

An alternative embodiment that adds utility deals with handling a user 10 who has used the service before, but not from the number represented by call 12. It is possible that user 10 has used the service before, but with another number. If so, user 10 can be prompted with a question asking if he has registered on the website. If so, he can be prompted for the primary number associated with his account, and the new number he is calling from is conditionally added to his account in database 10. This number is still subject to the verification steps for an “assigned” number described below. This optional feature is not shown in FIG. 1.

Another option that adds additional utility deals with authentication of a user. See block 27 in FIG. 1. If user 10 is known, a PIN (personal identification number) may be gathered to verify that the caller ID is trusted. Gathering of the PIN may be disabled by a setting on the account for user 10, which user 10 can manipulate on the website corresponding to the service. However, for security reasons, the default is to leave it enabled. If user 10 is found, PBX integrator 16 sends message 28, “getDigits (user.PIN),” to PBX server 14, causing PBX server 14 to allow the entry of DTMF codes (key presses on the telephone). A request 30 such as “Enter your PIN” is sent by PBX server 14 to user 10. User 10 responds by entering a PIN 32 that is relayed by communication 34, “send(PIN)” to PBX integrator 16. If necessary, the steps in block 27 are repeated. If authentication is successful, PBX integrator 16 creates a new user record in database 22; the record includes, for example, current time, and other fields of information as may be desired. If this authentication option is not employed, the block in FIG. 1 is skipped, and the process continues with message 36, “createRecording(Number).”

After the description has played or PIN verification has completed, PBX integrator 16 instructs PBX server 14 to create a record for the forthcoming recording via communication 36. Initially, this record may contain details such as the current time for billing purposes. It then instructs the PBX to start the audio recording via communication 37, “startRecording(recording)” with a message, for example, “Your recording will start after the beep.” A tone 38 is heard following the message, and recording 40, “Produce Audio,” starts. From this point on, any audio 40 is captured by PBX server 14 and, in this embodiment, written to a local file on local disk storage of PBX server 14. When the recording terminates because the user sends “FinishCall” 42 by hanging up, or by pressing a key such as the octothorpe key, or remaining silent for some length of time, PBX server 14 initiates an action 44 “sendFile (recording, file)”. The “file” variable is a handle denoting the location of the file. In one implementation, where PBX server 14 and PBX integrator 16 exist on the same machine, as described below, the handle is simply a file name on that machine. Once PBX integrator 16 receives message 44, it updates the database record via “updateRecording(recording)” 46 with the URL representing the location of the recorded file. PBX integrator 16 then sends “storageUpload(recording)” 48 to Async File Uploader 50. Uploader 50 subsequently moves the file to a storage location, such as Amazon's S3 storage service, not shown in FIG. 1. Uploader 50 may also delete the local file. After PBX integrator 16 has updated the record and sent the upload message, it sends “hangupCall” 52 to PBX server 14. This action can occur anytime after message 44.

Once uploaded, this file would be available at a URL (uniform resource locator) such as:

http ://s3.amazonaws.com/handmic/1234567890/1.wav. “1234567890” represents the telephone number for user 10. In this example, the file format is .wav, but many suitable formats are known. Some of the principal formats besides .wav are .mp3, aiff, .ogg,. raw, .au, .gsm, .aac, .wma, or .ra.

The record in the database 22 for the recording contains this URL, so that the recording can always be reached. The upload process may be started in the background, since it may take some time to do, and any incoming calls should be processed while performing an upload. PBX integrator 16 communicates a message 48, “storageUpload(recording)” asynchronously to Async Uploader 50. PBX integrator 16 can then handle other tasks. However, the upload is typically fast since audio files are small.

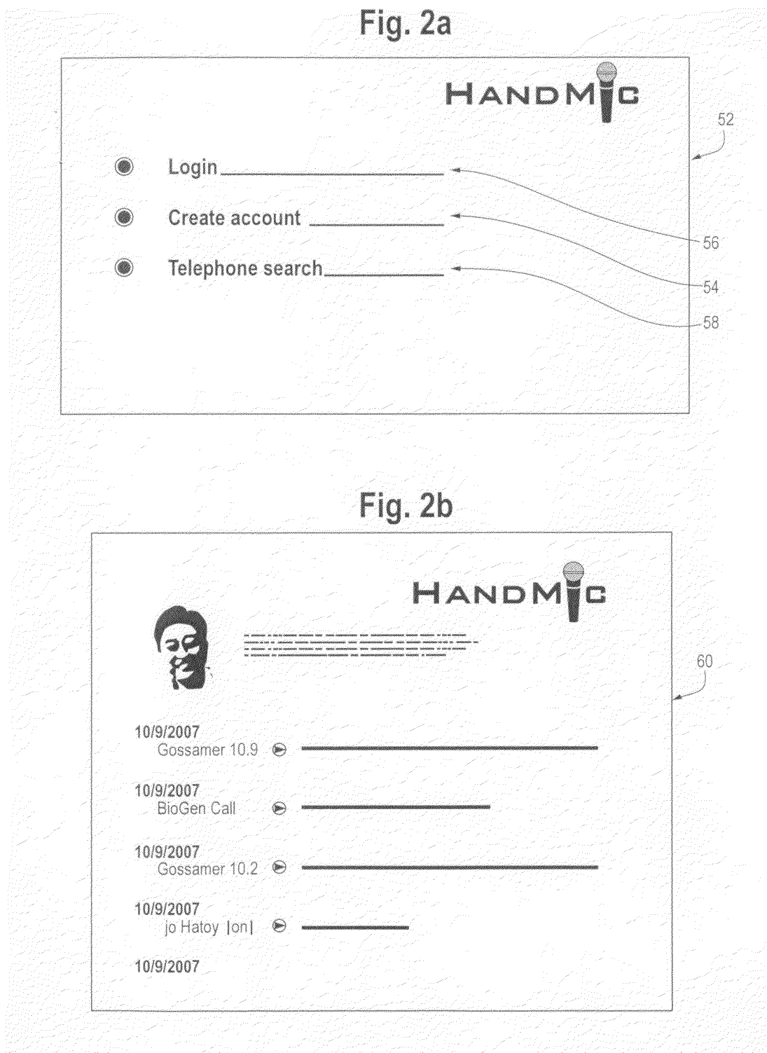

Now refer to FIG. 2. Once the file is uploaded, user 10, or in fact anyone, can go to a website, www.handmic.com in this example, to look for it. On a homepage 52 for the service, there will be a number of links or actions take can be taken. A new account 54 can be created on the service, an account holder can log in 56 to the service or search for audio by a phone number 58. Other options, not shown in FIG. 2a can be added to this page, such as the ability to see a list of the most played audio clips. Link 58 is most interesting to a user who has not previously registered, but has called in to make a recording. He simply enters his number, 1234567890, in the phone search box 58, and is taken to another page 60, a sample of which is shown in FIG. 2b, with the list of all publicly available calls recorded with that number. The record in the database 22 includes the URL where a particular audio is stored on S3. Thus, when a record is displayed, the display includes a hypertext link to the S3 URLs that the unregistered user can click on to immediately hear the associated audio content.

Normally, the content associated with this number is marked public for all to hear until that number is associated with a user 10 who has registered, that is, created an account on the system. Once an account has been created, there is another option that adds additional utility. The user, once authenticated, can change permissions on the content via the web page. For example, a user can create a number of authorization groups for his content, such as “friends,” “family,” and “work.” A user belongs to a group he owns, and can belong to groups that other users own and add him to. Recordings made by a user's telephone can be added to any or all of the groups owned by that user. Then, any users on the system that are a member of the groups that the recordings are added to can access the content in that group. That is, those users are allowed to see the database records for the recordings and the associated URLs on S3. A user can create new groups, add existing recordings to them, delete relationships between old groups and existing recordings, etc.

For example, there is a “superuser” or “admin” user on the system, which is normally protected by, for example, a password. This superuser or admin user has a special group called “Public.” When an unregistered user is added to the system, he is automatically added to this group owned by the admin, and may then access any recordings that are marked public. By default, recordings that come in for unknown users are added to this group and no others.

In another embodiment, a user may have multiple telephone numbers, and each one may have some default settings, and these settings need not be the same. For example, audio that is recorded on the number 1234567890 is added to the “home” group, and audio that is recorded on the number 2234567890 is added to the “work” group. This would be a configuration option set by the user on the web page. Very little input to the phone is necessary to initiate a recording.

Another embodiment adds protection against spoofing of caller ID. In this embodiment, an authentication mechanism is added for verifying that a user owns a telephone number he claims to own. For example, suppose a hacker calls the service with a spoofed caller ID 1234567890. After calling, the hacker goes to the web page, creates an account, and then goes to the “Add Phone” link 58 and adds this number. Then the real owner of 1234567890 attempts a recording from the real 1234567890. Unfortunately, this telephone number has already been “claimed” by the hacker. Because the hacker has an account, the real owner of 1234567890 could not find the recorded call on the web page if the hacker set the option on this number to make all recordings on it private by default. The real owner of 1234567890 would not be able to access recordings for this number.

The authentication mechanism in this embodiment can operate in several ways. An SMS (short message service) message can be sent to the added number, with a request that the user reply to it via SMS with a PIN number given out on the homepage; another embodiment would have the user receive the code in the SMS, but respond by calling the service's phone number and entering the assigned PIN upon request. SMS-based mechanisms work, but require a telephone capable of receiving SMS messages, which presently is not available on most POTS lines. Another alternative in this embodiment is where the PBX calls the number, plays a recording, and requests the user to enter the assigned PIN on the keypad. Outgoing calls cannot be spoofed. That is, a hacker cannot intercept an outgoing call to 1234567890 and pretend to be the owner of that number. This provides verification that the telephone belongs to the person claiming it, and allows verification of telephone calls from landlines as well as from cellular telephones.

In another embodiment, a user can create groups. Suppose a user has signed up, added a number, and wants recordings made with that number to belong to an access-restricted group by default, for example, “work”. Additionally, the user wants to make sure recordings are never made with spoofed caller IDs and added to that group by a hacker, which would potentially increase charges to the real user, require effort by the user to delete such recordings, or cause others in the private group to hear spoofed messages. So, when a user calls in and the number is recognized, and a second database lookup is performed that recognizes that that number belongs to a known user on the system, and furthermore that user's options are set to make recordings on that phone private, the user can be requested to enter a PIN before starting the recording, as shown in block 27 of FIG. 1. There are a number of other techniques for insuring security and privacy. Any of these techniques may be used, and may be configured by a user on the web page.

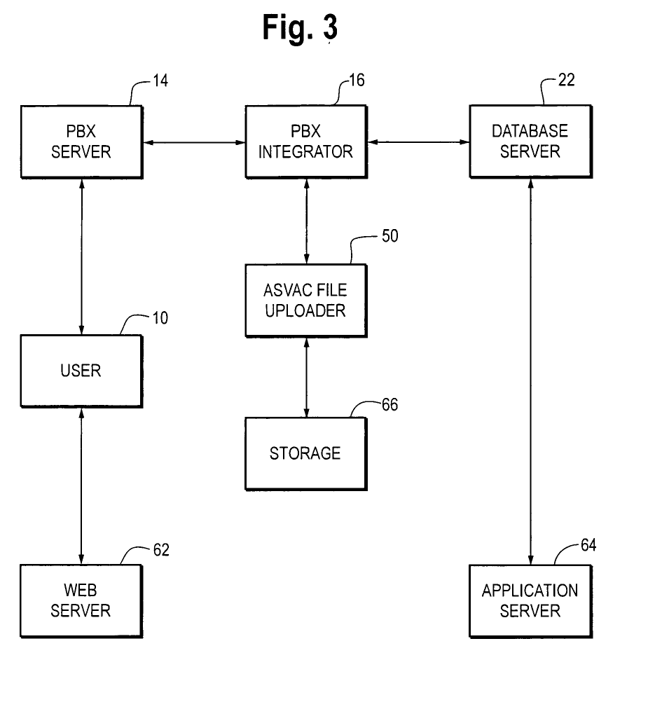

Refer to the block diagram, FIG. 3. Structurally, the service includes a webserver 62, an application server 64, the database server 22, PBX server 14, PBX integrator 16, and storage 66, such as Amazon's S3 service, accessible via Uploader 50. S3 is useful, but any type of storage could be used. The recordings could be stored locally and served through the webserver running the website. Or, they could be served from a webserver at another location that has access to the stored recordings). User 10 can communicate with PBX server 14 by telephone, or with webserver 62 via www.handmic.com.

Webserver 62, application server 64, database server 22, PBX server 14, PBX integrator 16 and Async File Uploader 50 may all exist as physical machines in one embodiment managed at an office, or in a traditional web hosting data center. In another, alternative embodiment, Amazon's EC2 service may be used. EC2 stands for “Elastic Cloud,” and is Amazon's compute service. Amazon exposes a public API that allows one to start, stop and query the status of Xen virtual machines running on Amazon's physical infrastructure. Xen is quite similar to Parallels or VMWare. If Amazon's EC2 service is used, the web, application and database servers 62, 64 and 22 reside on one Amazon EC2 instance. PBX server 14 and PBX integrator 16 reside on another Amazon EC2 instance, and have access to the database 22 via Amazon's internal network. Different partitions of the servers on VM instances within EC2 are possible. The allocation to one EC2 instance or the other can be made based upon the demands of a process for CPU time and memory. The allocation might also be affected by user demand; multiple webservers could be used. Webserver 62, application server 64 and database 22 on one EC2 instance provide the front end that runs handmic.com. On that site, a user can manage his telephones, recordings and groups. A user can also set his service options, including those regarding security.

In still other alternative embodiments, the service may be expanded to include a load balancer, multiple databases (such as read-only replicas for performance), and multiple PBX servers to handle higher call volume. The service is very adaptable, simply by using more VM instances in EC2, or more physical machines.

Those skilled in the art will appreciate that various changes, additions, omissions, and modifications can be made to the illustrated embodiments without departing from the spirit of the present invention. All such modifications and changes are intended to be covered by the claims.

We claim:

1. A method for recording audio information from a telephone call and making the recordings available on a website, including the steps of:
Initiating a telephone call to a telephone number routed to a PBX server;
Creating a record in the database including the telephone number of the caller;
Capturing an audio stream representing at least part of the content of the call;
Recording at least part of the audio stream to a file;
Transferring the file to a storage location;
Establishing a URL for the file at its storage location;
Associating the URL with the calling telephone number.

2. Whereby the file is accessible by a user via a hyperlink to the URL.

3. The method of claim 1 including the step of translating the telephone call from PSTN to a protocol compatible with the PBX server;

4. The method of claim 3 wherein the protocol is VoIP.

5. The method of claim 1 wherein the audio stream is recorded to a wav file.

6. The method of claim 1 wherein the audio stream is recorded to an mp3 file.

7. The method of claim 1 wherein the audio stream is recorded to one of a group of file formats, including at least .wav, .mp3, .aiff, .ogg, raw, .au, .gsm, .asc, .wma, or .ra.

8. The method of claim 1 wherein the record is created on a database server accessible to the PBX integrator.

9. The method of claim 1 wherein the storage location is a storage service, including Amazon S3.

10. The method of claim 1 wherein the hyperlink is accessed via a web server.

11. An apparatus comprising:
A publicly addressable server;
A PBX server adapted to receive and record telephone calls;
A PBX integrator in communication with the PBX server;
A database server in communication with the PBX integrator and the publicly addressable server for storing records;
A storage location accessible to a user via the publicly addressable server;
A file uploader connected to the PBX integrator, for receiving recorded telephone calls and uploading the recordings to the storage location; and
An application server in communication with the publicly addressable server and the database sever.

12. The apparatus of claim 11 where the PBX server is a virtual machine.

13. The apparatus of claim 11 where the PBX integrator is a virtual machine.

14. The apparatus of claim 11 where the database server is a virtual machine.

15. The apparatus of claim 11 where the publicly addressable sever is a web server.

16. The apparatus of claim 11 where the publicly addressable service is a virtual machine.

17. The apparatus of claim 11 where the application server is a virtual machine.

18. The apparatus of claim 11 where the storage location is a storage service.
